(19) United States
(12) Patent Application Publication
(10) Pub. No.: US 2026/0107086 A1
(43) Pub. Date: Apr. 16, 2026

(54) SOUND GENERATOR MODULE FOR WEARABLE ELECTRONIC APPARATUS AND WEARABLE ELECTRONIC APPARATUS

(71) Applicant: GOERTEK TECHNOLOGY CO., LTD, Qingdao, Shandong (CN)

(72) Inventor: Zhongxu ZHAO, Qingdao, Shandong (CN)

(21) Appl. No.: 19/114,868

(22) PCT Filed: Oct. 16, 2023
(86) PCT No.: PCT/CN2023/124786

§ 371 Date: Mar. 25, 2025

(30) Foreign Application Priority Data
Nov. 22, 2022 (CN) 202211467273.8

(51) Int. Cl. H04R 1/28

(52) U.S. Cl. CPC H04R 1/2896; H04R 1/288

(57) ABSTRACT

Disclosed in some embodiments of the present application are a sound generator module for wearable electronic apparatus and a wearable electronic apparatus. The sound generator module comprises a module housing; a sound generating unit, which is provided with a vibrating diaphragm on an end surface thereof; and an elastic connector, which is provided with a first connecting end and a second connecting end, the first connecting end is connected to the sound generating unit, the second connecting end is connected to inside of the module housing, and the elastic connector suspends the sound generating unit in the module housing; wherein the module housing is provided with a front sound cavity, to which the vibrating diaphragm is exposed, a front sound hole is provided in the module housing, and the front sound hole forms a relationship of being communicated with the vibrating diaphragm through the front sound cavity.

The present application claims the priority to the Chinese Patent Application No. 202211467273.8, entitled “sound generator module for wearable electronic apparatus and wearable electronic apparatus”, submitted to the China Patent Office on Nov. 22, 2022, all contents of which are incorporated herein by reference.

### TECHNICAL FIELD

The present invention belongs to a technical field of acoustic, and particularly relates to a sound generator module for wearable electronic apparatus and wearable electronic apparatus.

### BACKGROUND

With the rapid development of the virtual reality market, VR/AR products gradually enter the public view, and more and more consumers are willing to experience unprecedented visual experience brought by the VR/AR products. However, with the continuous iteration of VR/AR product video technology, the corresponding audio effect improvement has become an inevitable trend in the development of such products. Therefore, the acoustic performance of some low-power miniature loudspeakers cannot meet increasingly strict audio effect requirements, and the low-power miniature loudspeakers are replaced by the miniature loudspeakers with relatively large power and size. The increase in power of the loudspeaker can effectively improve the acoustic performance, but the increase in vibration intensity may interfere with other components in the electronic product. For example, an inertial sensor, a gyroscope, and the like are generally provided in a VR/AR apparatus, to identify a spatial location of the apparatus. If the vibration intensity of the loudspeaker is too large, the vibration may be detected by the above sensor, thereby causing erroneous detection of the sensor and interfering with normal use of the product. In more serious cases, damage to other components of the product may occur in the loudspeaker.

Therefore, it is necessary to improve the sound generation device in the electronic product to reduce the vibration interference applied to the outside.

### SUMMARY

An object of embodiment of the present application is to provide a new technical solution for a sound generator module for wearable electronic apparatus and a wearable electronic apparatus.

According to a first aspect of the embodiment of the present application, there is provided a sound generator module for wearable electronic apparatus, including:

a module housing;

a sound generating unit, wherein the sound generating unit is provided with a diaphragm on an end surface thereof; and

an elastic connector, wherein the elastic connector has a first connecting end and a second connecting end, the first connecting end is connected to the sound generating unit, the second connecting end is connected to inside of the module housing, and the elastic connector suspends the sound generating unit in the module housing,

wherein the module housing has a front sound cavity, the diaphragm is exposed to the front sound cavity, a front sound hole is provided in the module housing, and the front sound hole is communicated with the diaphragm through the front sound cavity.

Optionally, the elastic connector includes a front connector and a rear connector, and a first connecting end of the front connector is connected to an end surface of the sound generating unit.

Optionally, a first connecting end of the rear connector is connected to a side wall or a bottom surface of the sound generating unit.

Optionally, the elastic connector has an annular structure, the elastic connector surrounds the sound generating unit, and a first connecting end of the elastic connector surrounds the diaphragm and is connected to an end surface of the sound generating unit.

Optionally, the sound generator module further includes a connecting support member, wherein the connecting support member is fixed to the second connecting end of the elastic connector, and the connecting support member is configured to support the second connecting end; and

the connecting support member is fixed relative to an inner surface of the module housing.

Optionally, the sound generator module further includes a connecting support member, the connecting support member is disposed between the front connector and the rear connector, and the connecting support member is configured to provide relative support for the front connector and the rear connector.

Optionally, the connecting support member is connected between a second connecting end of the front connector and a second connecting end of the rear connector; and

the connecting support member is fixed and connected to an inner surface of the module housing.

Optionally, a support flange is formed inside the module housing, and a second connecting end of the elastic connector is fixed and connected with the support flange; and

the support flange is configured to divide a cavity inside the module housing so as to form the front acoustic cavity.

Optionally, the front sound hole is provided on a side surface of the module housing, and a direction in which the front sound hole is provided is relatively perpendicular to a vibration direction of the diaphragm.

Optionally, the elastic connector enables a floating direction of the sound generating unit to be parallel to a vibration direction of the diaphragm.

According to a second aspect of the embodiment of the present application, a wearable electronic apparatus is provided, wherein the above sound generator module is applied to the wearable electronic apparatus, the wearable electronic apparatus includes:

a main body and a wearing device, the wearing device is connected to the main body, and the wearing device is configured to wear the main body on a predetermined target; and

the sound generator module, which is disposed on the wearing device or the main body.

The embodiments of the present application have the following technical effects.

The elastic connector is disposed between the module housing and the sound generating unit, so that the elastic connector and the sound generating unit form an active vibration isolation structure. The present technical solution can weaken the transmission of vibration to the module housing and other peripheral components when the sound generating unit operates and reduce the interference influence on other components in the electronic product due to the sound generator module.

Other features and advantages of the present application will become apparent from the following detailed description of exemplary embodiments of the present application with reference to the accompanying drawings.

### BRIEF DESCRIPTION OF DRAWINGS

In order to describe the technical solutions in the embodiments of the present application or the related art more clearly, a brief introduction will be given to the drawings required for describing the embodiments or the related art in the following. It is obvious that the drawings described below are only a part of the drawings of the present application. For those skilled in the art, other drawings can be obtained based on the provided drawings without inventiveness labor.

FIG. 1 is a principle diagram of an active vibration isolation according to an embodiment of the present application;

FIG. 2 is a graph of variation of a damping factor according to an embodiment of the present application;

FIG. 3 is a schematic cross-sectional view of a sound generator module according to an embodiment of the present application;

FIG. 4 is a schematic cross-sectional view of a sound generator module according to an embodiment of the present application;

FIG. 5 is an exploded schematic diagram of a sound generator module according to an embodiment of the present application;

FIG. 6 is a schematic diagram of an application of a sound generator module according to an embodiment of the present application;

FIG. 7 is a test data diagram of a sound generator module according to an embodiment of the present application.

Reference numerals: sound generator module 100; sound generating unit 1; diaphragm 11; module housing 2; support flange 21; front sound cavity 22; front sound hole 23; elastic connector 3; front connector 31; rear connector 32; edge portion 33; connecting support member 4; human ear 8.

### DETAILED DESCRIPTIONS

The technical solutions in the embodiments of the present application will be described in conjunction with the accompanying drawings. Obviously, the described embodiments are only a part of the embodiments of the present application, and not all of the embodiments. Based on the embodiments in present application, all other embodiments obtained by ordinary skilled persons in this are without inventiveness labor are within the scope of protection of the present application.

In one embodiment, the present application provides a sound generator module 100 for wearable electronic apparatus, including: a module housing 2; a sound generating unit 1, wherein the sound generating unit 1 is provided with a diaphragm 11 on an end surface thereof; an elastic connector 3, wherein the elastic connector 3 has a first connecting end and a second connecting end, the first connecting end is connected to the sound generating unit 1, the second connecting end is connected to inside of the module housing 2, and the elastic connector 3 suspends the sound generating unit 1 in the module housing 2; wherein the module housing 2 has a front sound cavity 22, the diaphragm 11 is exposed to the front sound cavity 22, a front sound hole 23 is provided in the module housing 2, and the front sound hole 23 is communicated with the diaphragm 11 through the front sound cavity 22.

As shown in FIG. 3, a diaphragm 11 is provided on the end surface of the sound generating unit 1, the diaphragm 11 may be located at the end surface of the sound generating unit 1, and the diaphragm 11 can be seen from a surface of the sound generating unit 1, so that sound generated when the diaphragm 11 vibrates can be transmitted to the outside. A first connecting end of the elastic connector 3 is connected to the sound generating unit 1, a second connecting end of the elastic connector 3 is used for being connected to other fixing component, and the elastic connector 3 provides supporting and bearing effect with elastic buffering for the sound generating unit 1. When the sound generating unit 1 receives an electrical signal and causes the diaphragm to vibrate, on one hand, the sound generated by the sound generating unit 1 can be normally transmitted to the outside, and on the other hand, the sound generating unit 1 itself is inevitably driven by the diaphragm to generate vibration, and the vibration of the sound generating unit 1 itself is transferred to the elastic connector 3 connected with the sound generating unit 1, and the elastic connector deforms under the driving of the sound generating unit 1 to apply a buffering and absorbing effect on the vibration. The elastic connector 3 and the sound generating unit 1 itself form an active vibration isolation structure, that is, when the sound generating unit 1 vibrates, the elastic connector 3 can function to isolate the vibration, so as to reduce the transmission of the vibration generated when the sound generating unit 1 operates to the product main body portion through the solid structure of the product, thereby avoiding vibration of the sound generating unit 1 from affecting other peripheral components around the sound generating unit 1.

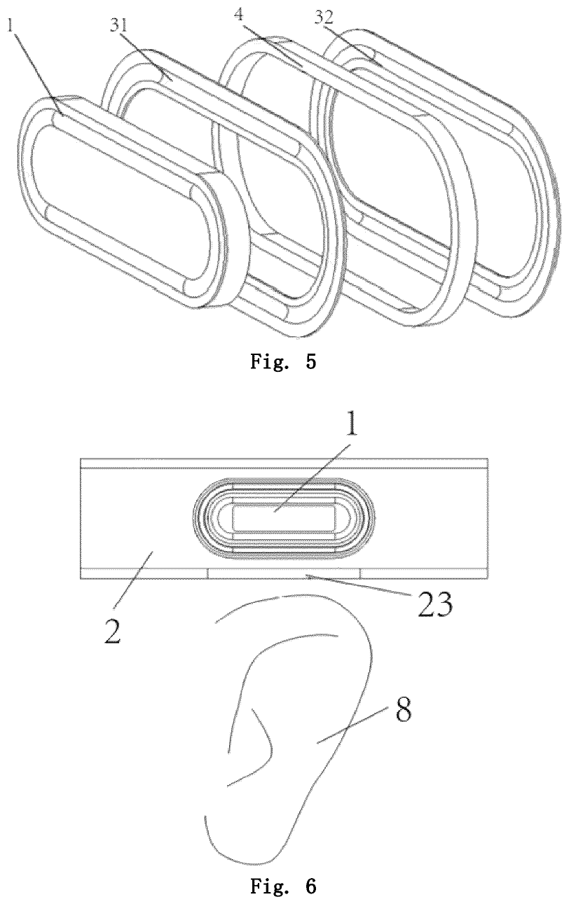

As shown in FIG. 4, the sound generating unit 1 and the elastic connector 3 are disposed in the module housing 2, a front sound cavity 22 is disposed in the module housing 2, an end surface of the sound generating unit 1 provided with the diaphragm 11 faces the front sound cavity 22 and is exposed to the inside of the front sound cavity 22, a front sound hole 23 is provided in the module housing 2, and the front sound hole 23 is in communication with the front sound cavity 22, so that the front sound hole 23 is communicated with the diaphragm 11 through the front sound cavity 22, and after the sound is generated when the diaphragm 11 operates to vibrate, sound waves may be transmitted to the outside via the front sound hole 23 through the front sound cavity 22. As shown in FIG. 4, the second connecting end of the elastic connector 3 is connected inside the module housing 2, that is, the elastic connector 3 provides an elastic supporting effect for the sound generating unit 1 connected to the first connecting end thereof, by means of the rigid supporting effect of the inner surface of the module housing 2. Under the supporting effect of the elastic connector 3, the sound generating unit 1 can normally generate sound and vibrate to some extent as the diaphragm vibrates. Preferably, the elastic connector 3 may be made of materials such as metal, plastic, plant fiber and the like capable of providing internal resistance and elasticity. The elastic connector 3 of such material can provide better cushioning and shock absorbing effect for the sound generating unit 1.

In this embodiment, optionally, the elastic connector 3 includes a front connector 31 and a rear connector 32, as shown in FIG. 3 to FIG. 5. The first connecting end of the front connector 31 is connected to the end surface of the sound generating unit 1.

In this embodiment, the first connecting end of the rear connector 32 is connected to a side wall or a bottom surface of the sound generating unit 1.

In this embodiment, the elastic connector 3 has an annular structure, the elastic connector 3 surrounds the sound generating unit 1, and the first connecting end of the elastic connector 3 surrounds the diaphragm 11 and is connected to the end surface of the sound generating unit 1.

As shown in FIG. 3, the elastic connector 3 includes a front connector 31 and a rear connector 32, and the front connector 31 is connected to the end surface of the sound generating unit 1 by adhesive or hot melt; the rear connector 32 may be connected to the side wall of the sound generating unit 1 by adhesive or hot melt, or the rear connector 32 may also be connected to the bottom surface of the sound generating unit 1 by adhesive or hot melt.

The front connector 31 and the rear connector 32 are used to provide elastic connection and support for the sound generating unit 1, so that the support and the buffer effect received by the sound generating unit 1 can be more uniform and balanced. For example, the front connector 31 is connected to the front end surface of the sound generating unit 1, and the rear connector 32 is connected to the bottom surface of the sound generating unit 1. In this way, the sound generating unit 1 can be elastically supported in two directions, namely, the front and rear directions, and when the diaphragm 11 vibrates, the vibration generated by the sound generating unit 1 itself can also be more stable and have a relatively fixed vibration direction. This can avoid phenomena such as deflection and tilting when the sound producing unit 1 vibrates itself, and this design has a good effect on the sound generating unit 1 to prevent the sound generating unit 1 from colliding with the inner wall of the module housing 2 or damaging the elastic connector 3 due to obvious deflection vibration. Further, the design of the front connector 31 and the rear connector 32 also prevents the vibration of the sound generating unit 1 itself from affecting the sounding effect, and if the vibration of the sound generating unit 1 itself is unstable, it may also cause a slight change in the sound transmission position and direction, or cause a reverse interference to the vibration of the diaphragm 11, thereby affecting the auditory experience of the user.

In other alternative embodiments of the present technical solution, only one elastic connector 3 may be used to support and buffer the sound generating unit 1, and the present technical solution does not exclude this implementation. In the case that the interior space of the sound generator module 100 is insufficient and the mass of the sound generating unit 1 is relatively small, and the like, it is not necessary to use two elastic connectors, namely, the front connector 31 and the rear connector 32.

Optionally, in an optional embodiment, the front connector 31 is connected to the front end surface of the sound generating unit 1, and the rear connector 32 is connected to the bottom surface of the sound generating unit 1. In this embodiment, the front connector 31 and the rear connector 32 are located on the front end and the rear end of the sound generating unit 1, so that it can provide a better balanced supporting effect for the sound generating unit 1. In another embodiment, the rear connector 32 may be connected to the side wall of the sound generating unit 1. That is, the bottom end region of the sound generating unit 1 protrudes slightly towards the bottom surface direction relative to the rear connector 32. This design is more suitable for a technical solution in which the thickness of the sound generator module 100 needs to be compressed or the internal space of the module housing 2 is insufficient. In this embodiment, the distance between the front connector 31 and the rear connector 32 is relatively closer, and the area occupied by the joint on the module housing 2 is relatively small, which is beneficial to saving space.

Optionally, on one hand, in order to enable the elastic connector 3 to provide a better vibration buffering effect for the sound generating unit 1 and serve a buffering performance similar to a spring, and on the other hand, in order to enable the structure of the elastic connector 3 to better adapt to the overall structural shape of the sound generating unit 1, the elastic connector 3 may be prepared into a structure similar to the diaphragm 11, for example, the elastic connector 3 has an edge portion 33. The bending extension structure of the edge portion 33 can form a better elastic deformation along a predetermined direction, and its structural form is similar to that of the diaphragm 11 which is the vibration main body, and it is easier to offset and buffer the vibration of the diaphragm 11. One or more elastic connectors 3 may be disposed around the sound generating unit 1, so that the edge portion 33 can form a buffer as the diaphragm 11 vibrates.

Further optionally, both the front connector 31 and the rear connector 32 can be provided with an edge portion 33, so as to form a vibration isolation structure isolated from the sound generating unit 1; when the sound generating unit 1 generates vibration in operation, the front connector 31 and the rear connector 32 may decompose the vibration into vibration of different degree due to the protrusions on the end surface, thereby reducing the transmission of the vibration generated when the sound generating unit 1 operates to the main body portion of the product through the solid structure of the product, and thus avoiding vibration of the sound generating unit 1 from affecting other peripheral components around the sound generating unit 1.

In a preferred embodiment, the front connector 31 and the rear connector 32 may be made of materials such as metal, plastic, plant fiber and the like capable of providing internal resistance and elasticity, and different materials may be simultaneously applied to the front connector 31 and the rear connector 32, so as to provide different damping to balance the uneven quality of the loudspeaker unit at different positions. For example, the front connector is made of metal, and the rear connector is made of plastic.

Optionally, the elastic connector 3 may have an annular structure, as shown in FIG. 3. The annular elastic connector 3 can provide uniform and stable elastic support from the periphery of the sound generating unit 1, which can effectively provide a guiding and buffering effect for the vibration of the sound generating unit 1 while improving the connecting reliability, thereby greatly reducing the influence on the outside due to the vibration of the diaphragm 11 and the sound generating unit 1.

Further, in the embodiment of adopting the front connector 31 and the rear connector 32, the first connecting end of the annular front connector 31 surrounds the diaphragm 11 and is connected to the end surface of the sound generating unit 1, so that the front connector 31 can receive the vibration generated when the sound generating unit 1 operates, and the transmission of the vibration to the product main body portion through the solid structure of the product can be reduced by the front connector 31. The front connector 31 is closer to the diaphragm 11 or directly in contact with the edge of the diaphragm 11, and the annular structure is more beneficial to receive the vibration from the diaphragm 11.

In an optional embodiment, the sound generator module may further include a connecting support member 4, the connecting support member 4 is fixed to the second connecting end of the elastic connector 3, and the connecting support member 4 is configured to support the second connecting end;

the connecting support member 4 is fixed relative to an inner surface of the module housing.

Optionally, in an embodiment provided with the front connector 31 and the rear connector 32, the connecting support member 4 is disposed between the front connector 31 and the rear connector 32, and the connecting support member 4 is configured to provide relative support for the front connector 31 and the rear connector 32.

Optionally, the connecting support member 4 is connected between the second connecting end of the front connector 31 and the second connecting end of the rear connector 32;

the connecting support member 4 is fixed and connected to the inner surface of the module housing 2.

In an embodiment, the connecting support member 4 is fixed to the second connecting end of the elastic connector 3, and the connecting support member 4 is connected to the elastic connector 3 by means of adhesive or hot melt. On one hand, the connecting support member 4 is used to fix the elastic connector 3 on the module housing 2, and on the other hand, the connecting support member 4 can further reduce the transmission of the vibration generated by the sound generating unit 1 to the module housing 2. Since the material of the elastic connector 3 is relatively soft and thus cannot be easily assembled with the inner surface of the module housing 2, the providing of the connecting support member 4, on the one hand, can provide support for the elastic connector 3 because the elastic connector 3 cannot be fixed to the module housing 2 by itself due to the relatively soft material thereof. On the other hand, the fixation and connection of the elastic connector 3 to the connecting support member 4 can provide fixing effect for the elastic connector 3. Therefore, the connecting support member 4 can have effect of matching connection and convenient assembly. The connecting support member 4 and the inner surface of the module housing 2 can be fixed and connected by means of ultrasonic welding, hot melt welding, and the like.

As shown in FIG. 3, in another embodiment, the connecting support member 4 is disposed between the second connecting end of the front connector 31 and the second connecting end of the rear connector 32, and upper and lower ends of the connecting support member 4 provide an overall supporting effect for the front connector 31 and the rear connector 32. The connecting support member 4 is connected to the front connector 31 by adhesive or hot melt, and the connecting support member 4 is connected to the rear connector 32 by adhesive or hot melt. On one hand, the connecting support member 4 is used to fix the front connector 31 and the rear connector 32 to the module housing 20, and on the other hand, the connecting support member 4 can further reduce the transmission of the vibration of the sound generating unit 1 to the module housing 2. Another advantage of this embodiment is that, the second ends of the front connector 31 and the rear connector 32 are integrally connected to the interior of the module housing 2 through the connecting support member, the structural consistency is improved, and it is difficult for the connection force applied on the module housing 2 by the front connector 31 and the rear connector 32 to be uneven and mutual pulling. In this way, the reliability of fixing the sound generating unit 1 to the module housing 2 is greatly improved.

Further, since the materials of the front connector 31 and the rear connector 32 are relatively soft and cannot be fixed to the module housing 2 by itself, the connecting support member 4 can provide a supporting effect for the front connector 31 and the rear connector 32. The front connector 31 and the rear connector 32 are fixed and connected to the connecting support member 4, and the supporting connector 4 can provide fixing effect for the front connector 31 and the rear connector 32.

As shown in FIG. 4, an outer end surface of the connecting support member 4 is connected to an inner surface of the module housing 2, and the connecting support member 4 is connected to the module housing 2 by adhesive or hot melt.

Optionally, a support flange 21 is formed inside the module housing 2, and the second connecting end of the elastic connector 3 is fixed and connected with the support flange 21;

the support flange 21 is configured to divide a cavity inside the module housing 2 so as to form the front acoustic cavity 22.

As shown in FIG. 4, a support flange 21 is formed inside the module housing 2, the second connecting end of the elastic connector 3 is fixed and connected with the support flange 21, wherein the elastic connector 3 is fixed and connected to the connecting support member 4, and the connecting support member 4 is fixed and connected to the support flange 21, so that the sound generating unit 1, the elastic connector 3 and the connecting support member 4 are all fixed inside the module housing 2. The providing of the support flange 21 is beneficial to provide a supporting effect for the sound generating unit 1 inside the module housing 2, thereby improving the supporting reliability, and making the assembly process relatively simpler. In addition, the front acoustic cavity 22 and the rear acoustic cavity of the sound generator module 100 generally do not form a communication relationship, and the areas of the front acoustic cavity 22 and the rear acoustic cavity can be more conveniently divided by using the connection relationship between the support flange 21 and the elastic connector 3, which is beneficial to simplify the structural complexity inside the sound generator module 100.

In a preferred embodiment, a damping ring is provided between the connecting support member 4 and the support flange 21, which can further reduce the transmission of the vibration of the sound generating unit 1 to the module housing 2.

Moreover, the sound generating unit 1, the elastic connector 3 and the connecting support member 4 divide a cavity inside the module housing 2 so as to form the front acoustic cavity 22.

In this embodiment, the front sound hole 23 is provided on a side surface of the module housing 2, and a direction in which the front sound hole 23 is provided is relatively perpendicular to a vibration direction of the diaphragm 11.

As shown in FIG. 6, a front sound hole 23 is provided in a side surface of the module housing 2, the front sound hole 23 is communicated with the diaphragm 11 through the front sound cavity 22, and a direction in which the front sound hole 23 is provided is perpendicular to a vibration direction of the diaphragm 11, so that a sound transmission direction can be changed, and sound heard by the human ear 8 is clearer.

In this embodiment, optionally, the elastic connector 3 enables the floating direction of the sound generating unit 1 to be parallel to the vibration direction of the diaphragm 11. For example, in a technical solution in which the elastic connector 3 is provided with an edge portion 33 and is similar to the diaphragm 11, the elastic connector 3 and the diaphragm 11 can be designed to be in a substantially parallel relative posture. In this way, in the vibration process, the elastic connector 3 can effectively apply a buffer and vibration isolation effect on the vibration of the diaphragm 11. Moreover, the vibration directions of the diaphragm 11 and the elastic connector 3 are substantially the same, and it is difficult to have the risks of mutual pulling and collision between the components, thereby ensuring the structural reliability.

As shown in FIG. 4, the elastic connector is fixed and connected to the sound generating unit 1, so that the elastic connector 3 can also ensure that the vibration of the sound generating unit 1 remains horizontal, that is, the vibration direction of the sound generating unit 1 is parallel to the vibration direction of the diaphragm 11, while providing internal resistance and elasticity, thereby reducing nonlinear vibration caused by fixing failure.

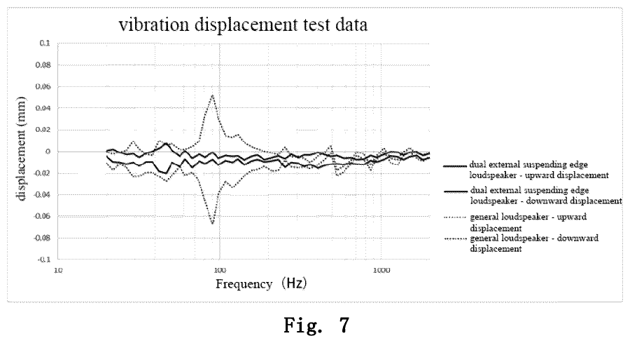

As shown in FIG. 7, the Y-axis is the magnitude of the vibration displacement of the product and the X-axis is the use frequency of the product. It can be seen from the data that the vibration displacement of the sound generator module 100 at the frequency of 90 Hz is significantly smaller than the vibration displacement of the general loudspeaker, and thus it can be seen that the elastic connector 3 and the weight of the sound generating unit 1 itself form an active vibration isolation system, that is, the elastic connector 3 can function to isolate the vibration when the sound generating unit 1 vibrates, so as to reduce the transmission of the vibration generated when the sound generating unit 1 operates to the product main body portion through the solid structure of the product, thereby avoiding the vibration of the sound generating unit 1 from affecting the vision and feeling of the user when the product is used.

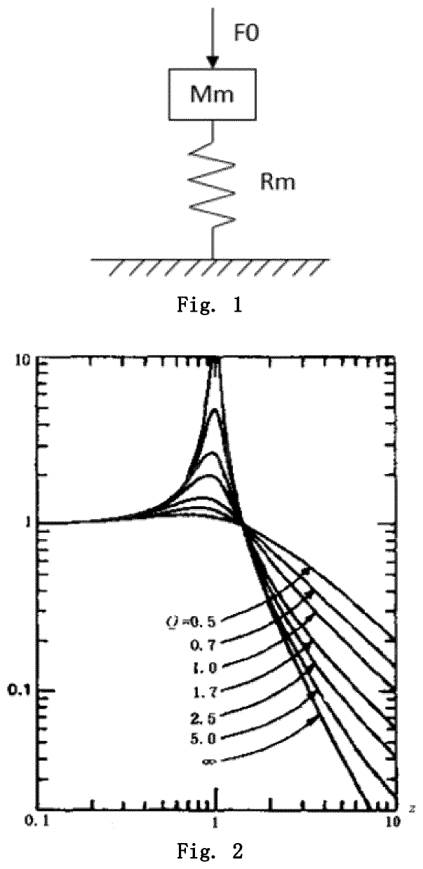

An application principle of the sound generator module 100 is as follows: as shown in FIG. 1, mass Mm represents a device that needs to eliminate external interference, wherein a simple harmonic force FO is applied on the device; if the device is directly placed on one solid, the simple harmonic force will be directly transmitted to the solid through the mass Mm, and therefore the solid may affect the external environment, and a spring with force resistance Rm can be added between the mass Mm and the solid in order to isolate the vibration from the outside, so that the force F transmitted to the solid through the spring is greatly weaker compared with FO, wherein the sound generating unit is equivalent to the mass Mm in the principle diagram, the elastic connector is equivalent to the spring with force resistance Rm in the principle diagram, and the solid is equivalent to a product.

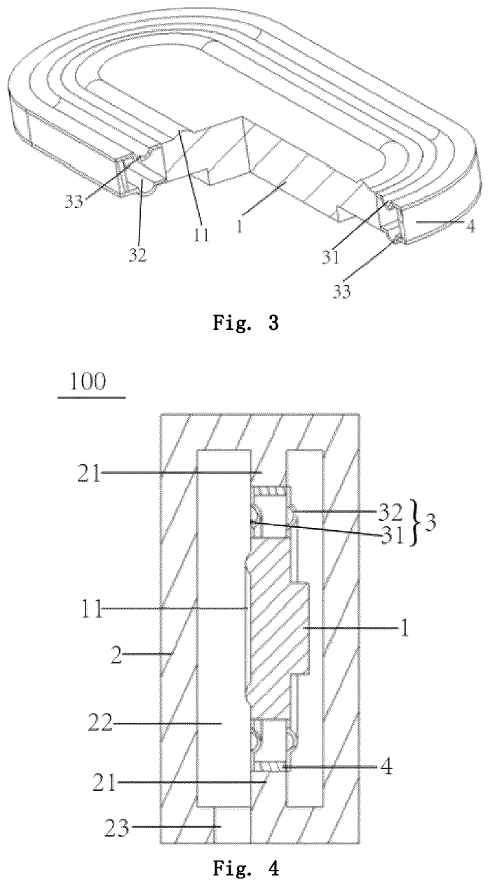

As the Q variation graph shown in FIG. 2, the vertical axis is D_{F}, the horizontal axis is z, and the curve is Qm, wherein D_{F} is the transfer ratio, z is the frequency ratio, Q is the damping factor, and the curves with different damping factors are marked in the figure, wherein the values of Q are respectively 0.5, 0.7, 1.0, 1.7, 2.5, 5 and, and ∞. It can be seen from the curve in the figure that, when z=z_{c}=√2, there is a boundary line, and the transfer ratio greater than the value is always less than 1, and becomes smaller and smaller as Q increases, while the transfer ratio less than the value is always greater than 1, and there is also a peak value, and therefore only when the frequency f>√2 f₀, the spring can function to isolate the vibration, and the further the frequency is away from the natural frequency of the system, the better the vibration isolation, and in this case, the F0 applied on the Mm and transmitted to the base through the Rm will be greatly suppressed.

In addition, an embodiment of the present application further provides a wearable electronic apparatus, including: a main body and a wearing device, wherein the wearing device is connected to the main body, and the wearing device is configured to wear the main body on a predetermined target; and the sound generator module 100, the sound generator module 100 is disposed on the wearing device or the main body.

In this embodiment, the wearable electronic apparatus is a VR/AR product, and the sound generator module 100 is disposed in the main body or the wearing device.

An inertial sensor is usually disposed in the VR/AR product, and when the sound generating unit 1 vibrates and transmits the vibration to the product, the performance of the inertial sensor is affected, thereby affecting the experience of the user; on the other hand, when the sound generating unit 1 vibrates and transmits the vibration to the product, the product will vibrate accordingly, and because the sound producing unit 1 is a wearable product, the user will feel the vibration of the product, it also affects the experience of the user, therefore the above sound generator module 100 is disposed in the VR/AR product, so that the above problems can be avoided.

The embodiments in this specification are described in a parallel or progressive manner, each embodiment is described by focusing on differences from other embodiments, and the same or similar parts among the embodiments may be referred to each other. For the device disclosed in the embodiments, since it corresponds to the method disclosed in the embodiments, the description is relatively simple, and reference may be made to the description of the method.

A ordinary skilled person in the art may further understand that the units and algorithm steps of the examples described with reference to the embodiments disclosed in this specification can be implemented by using electronic hardware, computer software, or a combination thereof. In order to clearly illustrate the interchangeability of hardware and software, the composition and steps of each example have been generally described in the above description according to their functions. Whether these functions are implemented in hardware or software depends on the specific application and design constraints of the technical solution. A skilled in the art may implement the described functionality by using different methods for each particular application, but such implementation should not be considered to be beyond the scope of the present application.

The steps of a method or algorithm described in combination with the embodiments disclosed herein may be implemented directly in hardware, a software module executed by a processor, or a combination thereof. The software module may be disposed in a random access memory (RAM), a memory, a read-only memory (ROM), an electrically programmable ROM, an electrically erasable programmable ROM, a register, a hard disk, a removable disk, a CD-ROM, or any other form of storage medium known in the art.

It should also be noted that, herein, relational terms such as first and second are merely used to distinguish one entity or operation from another entity or operation, without necessarily requiring or implying any such actual relationship or order between these entities or operations. Moreover, the terms “include”, “comprise”, or any other variant thereof are intended to cover a non-exclusive inclusion, such that a process, method, article, or apparatus including a series of elements includes not only those elements, but also other elements not explicitly listed, or elements inherent to such process, method, article, or apparatus. Without more limitations, an element defined by the statement “including a.” does not preclude the presence of another identical element in a process, method, article, or apparatus that includes the elements.

1. A sound generator module for a wearable electronic apparatus, comprising:
a module housing;
a sound generating unit, wherein the sound generating unit is provided with a diaphragm on an end surface thereof; and
an elastic connector, wherein the elastic connector has a first connecting end and a second connecting end, the first connecting end is connected to the sound generating unit, the second connecting end is connected to inside of the module housing, and the elastic connector suspends the sound generating unit in the module housing,
wherein the module housing has a front sound cavity, the diaphragm is exposed to the front sound cavity, a front sound hole is provided in the module housing, and the front sound hole is communicated with the diaphragm through the front sound cavity.

2. The sound generator module according to claim 1, wherein the elastic connector comprises a front connector and a rear connector, and a first connecting end of the front connector is connected to the end surface of the sound generating unit.

3. The sound generator module according to claim 2, wherein a first connecting end of the rear connector is connected to a side wall or a bottom surface of the sound generating unit.

4. The sound generator module according to claim 1, wherein the elastic connector has an annular structure, the elastic connector surrounds the sound generating unit, and the first connecting end of the elastic connector surrounds the diaphragm and is connected to the end surface of the sound generating unit.

5. The sound generator module according to claim 2, further comprising a connecting support member, wherein the connecting support member is disposed between the front connector and the rear connector, and the connecting support member is configured to support the front connector and the rear connector.

6. The sound generator module according to claim 5, wherein the connecting support member is connected between a second connecting end of the front connector and a second connecting end of the rear connector; and
the connecting support member is fixed and connected to an inner surface of the module housing.

7. The sound generator module according to claim 1, wherein a support flange is formed inside the module housing, and the second connecting end of the elastic connector is fixed and connected with the support flange; and
the support flange is configured to divide a cavity inside the module housing, so as to form the front acoustic cavity.

8. The sound generator module according to claim 1, wherein the front sound hole is provided on a side surface of the module housing, and a direction in which the front sound hole is provided is perpendicular to a vibration direction of the vibrating diaphragm.

9. The sound generator module according to claim 1, wherein the elastic connector enables a floating direction of the sound generating unit to be parallel to a vibration direction of the vibrating diaphragm.

10. A wearable electronic apparatus, comprising:
a main body and a wearing device, wherein the wearing device is connected to the main body, and the wearing device is configured to wear the main body on a predetermined target; and
the sound generator module according to claim 1, wherein the sound generator module is disposed on the wearing device or the main body

11. The sound generator module according to claim 1, wherein the diaphragm can be seen from a surface of the sound generating unit.

12. The sound generator module according to claim 1, wherein the second connecting end of the elastic connector is connected to another fixing component.

13. The sound generator module according to claim 1, wherein the elastic connector provides an elastic supporting effect for the sound generating unit connected to the first connecting end thereof.

14. The sound generator module according to claim 1, wherein only one elastic connector is provided to support and buffer the sound generating unit.

15. The sound generator module according to claim 3, wherein a bottom end region of the sound generating unit protrudes slightly towards a direction of the bottom surface relative to the rear connector.

16. The sound generator module according to claim 1, wherein the elastic connector has an edge portion.

17. The sound generator module according to claim 2, wherein at least one of the front connector and the rear connector is provided with an edge portion.

18. The sound generator module according to claim 5, wherein a support flange is formed inside the module housing, and
wherein a damping ring is provided between the connecting support member and the support flange.
